(19) United States
(12) Patent Application Publication
(10) Pub. No.: US 2004/0235317 A1
(43) Pub. Date: Nov. 25, 2004

(54) Housing system for an electric device

(76) Inventor: Peter Schiefer, Unterheinriet (DE)

Correspondence Address: Striker Striker & Stenby, 103 East Neck Road, Huntington, NY, 11743, US

(21) Appl. No.: 10/488,270

(22) PCT Filed: Dec. 19, 2002
(86) PCT No.: PCT/DE02/04664

(30) Foreign Application Priority Data
Dec. 20, 2001 (DE) 101 62 600.2

(51) Int. Cl. H01R 12/00

(52) U.S. Cl. 439/76.2

(57) ABSTRACT

The invention relates to a housing device for an electrical device (1), with at least two housing parts (2, 3) and an electronic circuit on a printed circuit board (4), which can be disposed in the device (1) and has a conductive layer that is connected to the housing mass of at least one metallic housing part (2). A housing part (3) is a plastic part into which is integrated at least the connecting device (9) for supplying power to the device and/or for transmitting signals to the electronic circuit. The printed circuit board (4) is equipped on both sides: components (5) that are sensitive to radiated interference are disposed on the side that is largely enclosed by the metallic housing part (2) and the conductive layer, and other components (6) and contacts of a connecting device (9) are disposed on the other side of the printed circuit board (4).

### PRIOR ART

The invention relates to a housing assembly for an electrical device, in particular for a control or regulating unit with an electronic circuit on a printed circuit board, as generically defined by the preamble to the main claim.

When manufacturing such a housing for an electrical device, in particular for controlling electromechanical units for example in a motor vehicle, care must be taken to assure that not only as snug and vibration-free as possible a connection of the housing parts, but also a favorable electromagnetic shielding (EMC) for the control unit electronics as well as a favorable heat dissipation can be achieved for the lowest possible production cost.

DE-OS 39 37 190 has already disclosed an electrical device in which the control unit electronics for components of an internal combustion engine are disposed in a housing that is mounted in the vicinity of the motor units. The two-part housing comprised of metal, for example die-cast aluminum, can be sealed in an electromagnetically shielded fashion; a connecting device for connection lines, a so-called multipoint plug, is integrated into the housing and can supply power as well as transmit measurement and control signals. These aluminum housings are as a rule very costly and heat is dissipated via the housing cover, which can potentially involve a relatively long path to the heat sink.

DE 42 43 180 A1 has disclosed a multi-part housing for control units in which, in order to produce a favorable imperviousness to radiated interference and a favorable heat dissipation, a printed circuit board supporting the power components and the control components is provided with a continuous lining made of electrically conductive material. The printed circuit board is clamped here in the vicinity of these lined areas, with an electrically conductive connection between the housing halves. As a result, control elements that are radiated interference-intensive or those that are sensitive to radiated interference are enclosed by supports protruding from the walls of the housing parts.

### ADVANTAGES OF THE INVENTION

According to the invention, the housing device described at the beginning, with at least two housing parts and an electronic circuit on a printed circuit board, which can be disposed in the housing and has a conductive layer connected to the housing mass of at least one metallic housing part, is advantageously modified through the addition of the characterizing features of claim 1.

Preferably, the respective other housing part here is a plastic part into which is integrated the at least one connecting device for supplying power to the device and/or for transmitting signals to the electronic circuit. The connecting device here can easily be disposed, for example, in the middle of the plastic housing part, thus producing short conduction paths, which are favorable in terms of radiated interference, to the power components, which are often disposed in different edge regions for thermal reasons.

According to the invention, the printed circuit board can advantageously be equipped on both sides: components that are sensitive to radiated interference are disposed on the side that is largely enclosed by the metallic housing part and the conductive layer. Other components and contacts of one or more connecting devices are then disposed on the other side of the printed circuit board.

In addition, power components are advantageously disposed on the side of the printed circuit board opposite from the connecting device and also in the region in which the printed circuit board is attached to the metallic housing part. The printed circuit board can be comprised in the conventional manner of a substrate or laminate or can also be embodied as a foil.

The invention makes it easily possible to assure that the housing of a control unit can be optimized in terms of cost and production. A reduction in the number of individual parts and manufacturing steps can be achieved; despite the use of a plastic housing part, the critical EMC requirements can be taken into consideration because all of the EMC-critical components can be disposed on the side of the printed circuit board opposite from the metallic part, e.g. the lower part of the housing.

Together with the shielding surface, e.g. a copper layer, the printed circuit board that is contacted by the metallic lower part constitutes an approximate Faraday cage that can effectively suppress undesired incoming and outgoing radiation. If the power components and the connecting devices are disposed together with the contacts on the other side of the printed circuit board, then the shielding effect of the EMC-critical components can be even further reinforced and the conductor routing on the printed circuit board can be further simplified at the same time.

The heat dissipation from the power components can occur in the region in which the printed circuit board is attached to the metallic housing part, thus permitting a shorter contact to a heat sink. It is also possible to attach additional cooling ribs to the metallic housing part, e.g. through the use of air currents as when cooling is provided in the region of the air filter of a motor vehicle.

The housing according to the invention is advantageously modified if the housing part with the connecting device is provided with hold-down elements and/or springs in order to stabilize the position of the printed circuit board or of particular components during assembly, e.g. for the soldering process, or after assembly in order to increase vibration resistance. Also, the formation of ribs in the plastic component serves to further stabilize and increase the vibration resistance of the device.

The housing part made of plastic can easily also have a pressure compensation element mounted in it, which can be inset in a recess in particular by being cast in place with plastic during manufacture of the housing part or by being subsequently snapped in by means of snap hooks.

In order to permit a simple production of sealed housings, a seal running along the contour of the housing parts can be mounted directly between the housing parts that contact each other. The sealing contour here is merely disposed in a plane between the housing parts and is not attached to the printed circuit board. Using the plastic housing part as a cover assures an insulation of the inner air in relation to possibly high surrounding temperatures.

The connecting device can advantageously be provided with straight contact pins that are guided directly on the printed circuit board. This permits the elimination of a possibly required guide strip and permits the selection of a type of contact that is inexpensive to produce, e.g. by means of press-fitting or partial soldering. The plastic housing part here can also be inexpensively provided with shoulders that support the pins while they are being press-fitted.

The housing part with the connecting device made of plastic can also be easily provided with an inner metallization in order to increase the EMI reliability of the entire device. However, it is also possible in this regard for the plastic housing part, with the inclusion of the connecting device, to be enclosed by an additional metallic or metallized housing part.

### DRAWINGS

An exemplary embodiment of a housing according to the invention for an electrical control unit for a vehicle will be explained in conjunction with the drawings.

FIG. 1 shows a vertical section through the housing of an electrical control unit with a printed circuit board that is equipped on both sides and

FIG. 2 shows a top view of the housing according to FIG. 1.

### DESCRIPTION OF THE EXEMPLARY EMBODIMENT

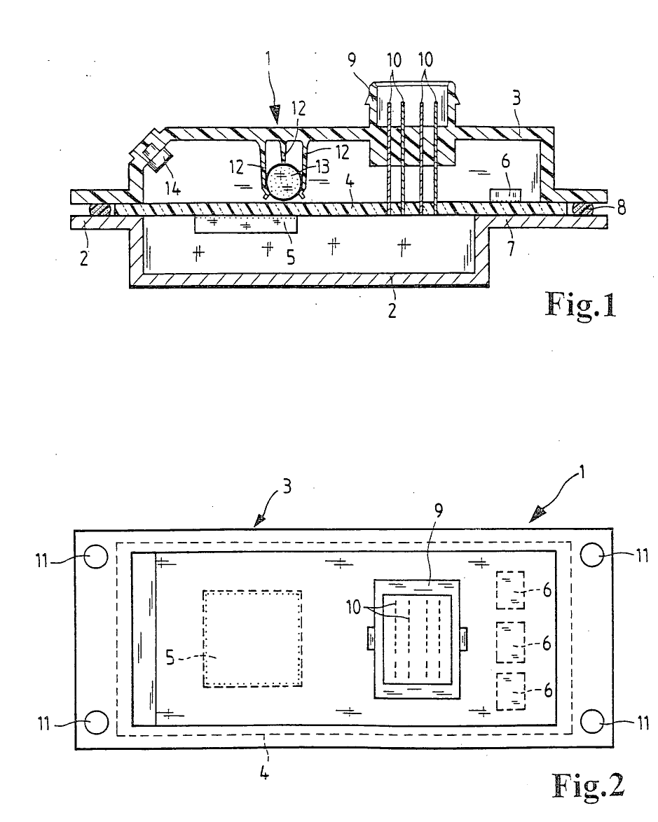

FIG. 1 shows a sectional view of a control unit 1 with a lower housing part 2 made of metal, e.g. die-cast aluminum, and an upper housing part 3 made of plastic. Between the two housing parts 2 and 3, there is a printed circuit board 4, which is provided in a manner not shown here with a conductive layer, which is in turn contacted by the metallic housing part 2.

Components 5 of the electronic circuit of the control unit 1 are mounted to the underside of the printed circuit board 4 and thus thus lie in an EMI-hardened position between the metallic lower part 2 of the housing and the conductive layer of the printed circuit board 4.

Power components 6 are mounted on top of the printed circuit board 4 and are disposed in a region of the printed circuit board 4 that rests directly on the lower housing part 2 so that a part 7 of the lower housing part 2 can serve as a cooling surface for the power components 6. It is also possible to provide cooling ribs, not shown here, on the lower part 2 in order to take advantage of air currents. The housing cover 3 can also be provided with hold-down elements and/or springs 12, likewise not shown, in order to stabilize the position of the printed circuit board 4 or of other components 13, e.g. electrolytic capacitors, during assembly, e.g. for the soldering process, or after assembly in order to increase resistance to vibration.

A continuous seal 8 is also placed between the housing parts 2 and 3 in order to seal the entire device 1. The sealing contour here is disposed in a plane between the housing parts 2 and 3 and is not attached to the printed circuit board 4.

The upper housing part 3, the cover of the device 1, has a multipoint plug 9 integrated into it as at least one connecting device for supplying power to the device and/or for transmitting signals to the electronic circuit on the printed circuit board 4. The multipoint plug 9 here is provided with straight contact pins 10 that are guided directly on the printed circuit board 4; a favorable type of contact, e.g. a press-fitting or partial soldering, can be provided here for the contact pins 10. A pressure compensation element 14 is also disposed in the housing part 3 and can be inset by being cast in place during the manufacture of the housing part 3 or by being subsequently snapped in by means of snap hooks.

FIG. 2 shows a top view of the control unit 1 according to FIG. 1, depicting the contact pins 10 and the housing cover 3 with fastening holes 11 for the entire housing and the connecting device with the multipoint plug 9. The printed circuit board 4, the electronic components 5, and the power components 6, which cannot be seen, are depicted with dashed lines.

1. A housing device for an electrical device (1), with
at least two housing parts (2, 3) and an electronic circuit on a printed circuit board (4), which can be disposed in the device (1) and has a conductive layer that is connected to the housing mass of at least one metallic housing part (2), characterized in that
the respective other housing part (3) is a plastic part into which is integrated at least the connecting device (9) for supplying power to the device and/or for transmitting signals to the electronic circuit.

2. A housing device for an electrical device (1), with
at least two housing parts (2, 3) and an electronic circuit on a printed circuit board (4), which can be disposed in the device (1) and has a conductive layer that is connected to the housing mass of at least one metallic housing part (2), characterized in that
the respective other housing part (3) is a plastic part and the printed circuit board (4) is equipped on both sides, wherein components (5) that are sensitive to radiated interference are disposed on the side that is largely enclosed by the metallic housing part (2) and the conductive layer, and in that other components (6) and contacts of a connecting device (9) are disposed on the other side of the printed circuit board (4).

3. A housing with a combination of the features of claim 1 and claim 2.

4. The housing according to claim 1, characterized in that
power components (6) are disposed on the side of the printed circuit board (4) opposite from the connecting device (9), in the region (7) in which the printed circuit board (4) is attached to the metallic housing part (2).

5. The housing according to claim 1, characterized in that
the housing part (3) with the connecting device (9) is provided with hold-down elements and/or springs (12) in order to stabilize the position of the printed circuit board (4) or the components (13) after assembly.

6. The housing according to claim 1, characterized in that
directly between the housing parts (2, 3) that rest against each other, a seal (8) is provided, which extends around the contour of the housing part (2, 3).

7. The housing according to claim 1, characterized in that
the connecting device (9) is provided with contact pins (10) that are guided directly on the printed circuit board (4).

8. The housing according to claim 7, characterized in that
the contact pins (11) are brought into contact with the strip conductors of the printed circuit board (4) by means of press-fitting.

9. The housing according to claim 7, characterized in that
the contact pins (11) are brought into contact with the strip conductors of the printed circuit board (4) by means of soldering.

10. The housing according to claim 1, characterized in that
the housing part (3) with the connecting device (9) made of plastic is provided with an internal metallization.

11. The housing according to claim 1, characterized in that
a pressure compensation element (14) is mounted in the housing part (3), in particular by means of being cast in place with plastic during the manufacture of the housing part (3).

12. The housing according to claim 1, characterized in that
the housing part (3) with the connecting device (9) is made of plastic and, with the inclusion of the connecting device (9), is enclosed by an additional metallic or metallized housing part.
